(19) United States
(12) Patent Application Publication
(10) Pub. No.: US 2019/0226441 A1
(43) Pub. Date: Jul. 25, 2019

(54) GENERATOR SET STARTUP USING RENEWABLE ENERGY

(71) Applicant: MTU Onsite Energy Corporation, Mankato, MN (US)

(72) Inventors: Justin Anderson, Lonsdale, MN (US); Dylan Brandt, Woden, IA (US)

(21) Appl. No.: 15/879,032

(22) Filed: Jan. 24, 2018

(51) Int. Cl. F02N 19/02; F02N 11/04; H02K 7/18

(52) U.S. Cl. CPC F02N 19/02; H02K 7/1815; F02N 11/04

(57) ABSTRACT

The disclosure describes a generator set that includes a generator, an engine mechanically coupled to the generator, an enclosure housing the engine and the generator, a heating system, and a renewable energy-powered energy source. The generator is configured to supply power to an electrical system. The heating system is configured to heat at least one of the engine or the enclosure to at least a startup temperature. The renewable energy-powered energy source is configured to supply energy to the heating system to heat the at least one of the engine or the enclosure.

### TECHNICAL FIELD

The disclosure relates to methods and systems for engine startup.

### BACKGROUND

A generator set, which includes a generator and an engine, may be operated infrequently and may remain stationary for extended periods of time. For example, generator sets may be used for standby power applications where expected use is limited to testing and emergency situations. During generator set startup, the generator set may be expected to startup in a limited period of time. For example, the National Fire Prevention Association's (NFPA) Standard for Emergency and Standby Power Systems requires a generator used for emergency power to startup in less than ten seconds from detection of a power outage to load acceptance.

### SUMMARY

In some examples, the disclosure describes a generator set that includes a generator, an engine mechanically coupled to the generator, an enclosure housing the engine and the generator, a heating system, and a renewable energy-powered energy source. The generator is configured to supply power to an electrical system. The heating system is configured to heat at least one of the engine or the enclosure to at least a startup temperature. The renewable energy-powered energy source is configured to supply energy to the heating system to heat the at least one of the engine or the enclosure.

In other examples, the disclosure describes a method that includes supplying, by a renewable energy-powered energy source, energy to a heating system of a generator set. The generator set includes the renewable energy-powered energy source, the heating system, a generator configured to supply power to an electrical system, an engine mechanically coupled to the generator, and an enclosure encasing the engine and the generator. The method further includes heating, by the heating system, at least one of the engine or the enclosure to at least a startup temperature. The method further includes discharging, by a starter battery system and in response to receiving a startup signal, electrical power to a starter system of the engine.

In other examples, the disclosure describes a controller configured to cause a renewable energy-powered energy source to supply energy to a heating system of a generator set. The generator set includes the renewable energy-powered energy source, the heating system, a generator configured to supply power to an electrical system, an engine mechanically coupled to the generator, and an enclosure encasing the engine and the generator. The controller is further configured to cause the heating system to heat at least one of the engine or the enclosure to at least a startup temperature. The method is further configured to cause a battery system to discharge, in response to receiving a startup signal, electrical power to a starter system of the engine.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1A is a conceptual and schematic block diagram illustrating an example system for maintaining a generator set at startup conditions using electrical renewable energy.

FIG. 1B is a conceptual and schematic block diagram illustrating an example system for maintaining a generator set at startup conditions using electrical renewable energy.

FIG. 2 is a flow diagram illustrating an example technique for maintaining a generator set at startup conditions using renewable energy.

### DETAILED DESCRIPTION

The disclosure describes systems and techniques for maintaining an engine of a generator set at startup conditions using renewable energy. According to principles of the disclosure, a generator set may be maintained at startup conditions using renewable energy. Renewable energy sources may produce relatively low levels of power that may be adequate to maintain the generator set at startup conditions or supplement auxiliary power over long periods of time. The generator set may include a generator, an engine, a renewable energy-powered energy source, a heating system, and an enclosure housing the engine and the generator. The heating system may be configured to receive energy from the renewable energy-powered energy source and use the energy to heat at least one of the engine or the enclosure. In some examples, the renewable energy source powering the renewable energy-powered energy source may be a thermal renewable energy-powered energy source that heats heat exchange fluid. For example, the thermal renewable energy source, such as a solar heater, may receive solar energy to produce thermal heat that may be used to directly heat the heat exchange fluid, such as through a heat exchanger. In some examples, the renewable energy source powering the renewable energy-powered energy source may include an electrical renewable energy-powered energy source to heat the heat exchange fluid or resistively heat components of the generator set. For example, the electrical renewable energy-powered energy source, such as a photovoltaic panel or wind turbine, may produce electricity used to heat an electric heater coupled to the heating system.

In some examples, the generator set may use renewable energy to heat or power other systems of the generator set. For example, the generator set may include a starting system coupled to an electrical renewable energy source, such as a photovoltaic panel and configured to charge a starter battery. As another example, the generator set may include a resistive heater configured to heat ambient air of an enclosure around the generator set using renewable energy, such as through an electrical heater or heat exchanger.

Some generator sets may be used for standby power and may be located in locations that experience low temperatures. For example, a cellular communication tower located in southern Minnesota may experience an average January low temperature of less than −15° C. In response to electrical power from an electrical grid being lost to the cellular communication tower, the generator set may startup. Generator set startup may include detecting a utility outage, drawing power from a starting system, bringing the engine to operating conditions, and connecting a load to the generator set.

Maintaining components of the generator set at a charged and/or adequately heated state may help ensure generator set startup in a limited amount of time. For example, a combustion engine may be configured to compress air to obtain a temperature for igniting fuel. If a temperature of the engine is low, the engine may take a longer time to reach an operating state such that the generator may supply electrical power above a threshold. As another example, a starter battery system may lose power over a period of time, especially in cold conditions. As yet another example, low temperature ambient air in a generator set enclosure may cause the starter battery system may undergo cold cycling, which may cause batteries of the starter battery system to discharge and reduce life expectancy.

The generator sets described herein may utilize renewable energy sources to provide energy to maintain components of the generator set at a startup temperature, to charge a power source for the starting system, or the like. Maintenance of the generator set components at adequate startup conditions may use significant energy over a period of time. By using alternative energy sources to maintain the generator set at startup operating conditions, the generator set may use less or no power from an electrical grid to maintain the startup operating conditions.

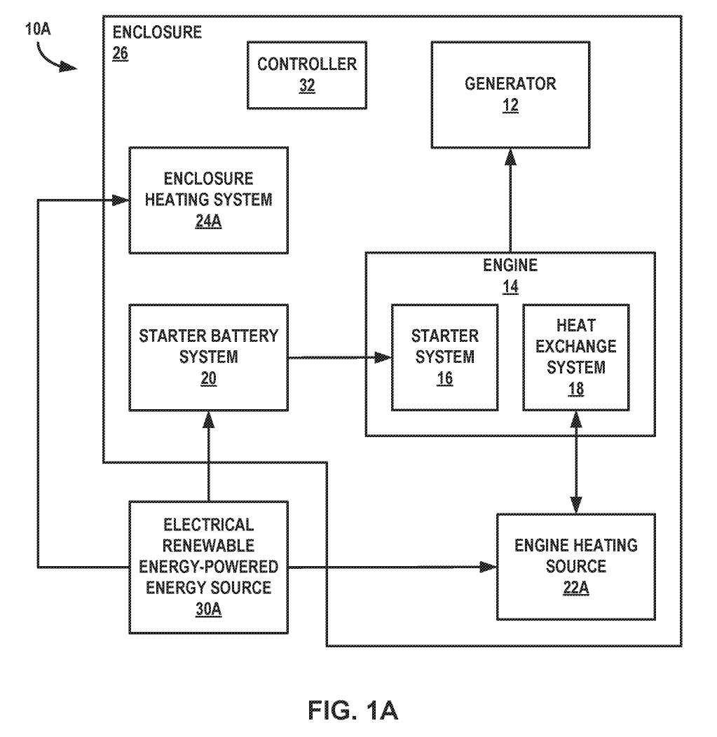

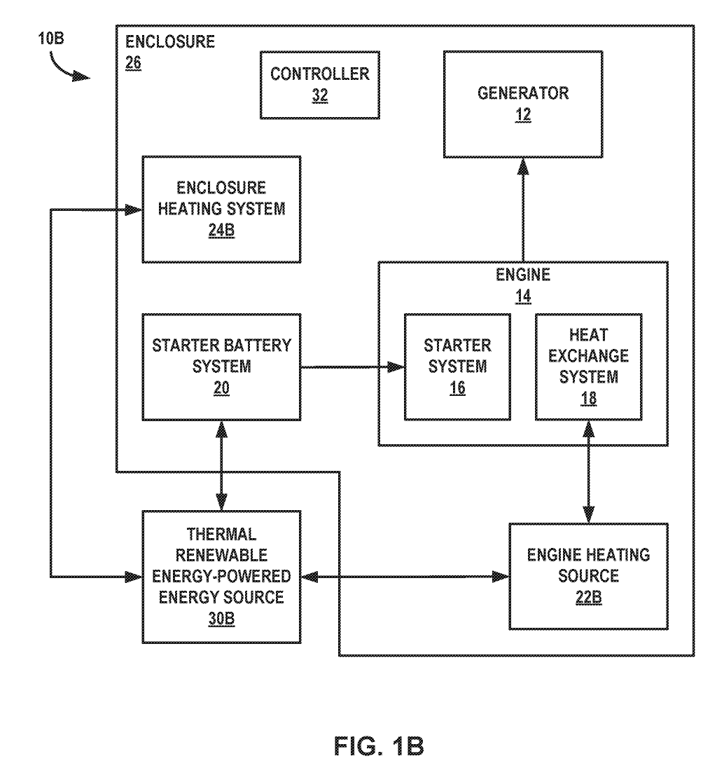

FIGS. 1A and 1B are conceptual and schematic block diagrams illustrating example systems 10A and 10B, respectively, for maintaining one or more components of a generator set (e.g., an engine) at startup conditions using renewable energy. Systems 10A and 10B may each include an enclosure 26, a generator 12, and an engine 14. Systems 10A and 10B may also include various accessory systems of enclosure 26, generator 12, and/or engine 14. In the example of FIG. 1A, system 10A may include any of a starter battery system 20, an engine heat source 22A, and an enclosure heating system 24A powered at least in part by electrical energy from electrical renewable energy-powered energy source 30A. Engine heating source 22A, a heat exchange system 18, and enclosure heating system 24A may be part of a heating system for system 10A. In the example of FIG. 1B, system 10B may include any of an engine heat source 22B and an enclosure heating system 20 powered at least in part by thermal energy from thermal renewable energy-powered energy source 30B. Engine heating source 22B, a heat exchange system 18, and enclosure heating system 24B may be part of a heating system for system 10B. Components of systems 10A and 10B may be controlled by controller 32.

Systems 10A and 10B may include enclosure 26. Enclosure 26 may encase or enclose at least generator 12 and engine 14. In some examples, enclosure 26 may be configured to shelter components of system 10 from exposure to external conditions. For example, enclosure 26 may include equipment or systems that protect components of systems 10A and 10B from rain, low temperatures, and the like. In some examples, enclosure 26 may be configured to provide a controlled environment around components of systems 10A and 10B. For example, enclosure 26 may provide a volume around components of systems 10A and 10B that may be controlled for ambient temperature, humidity, or other ambient conditions that may affect performance of engine 12 and/or generator 14.

Systems 10A and 10B include generator 12. Generator 12 may be mechanically coupled to engine 14, such as through a mechanical shaft or any other mechanical link configured to transfer mechanical energy from engine 14 to generator 12. Generator 12 may be configured to convert mechanical energy to electrical energy. Generator 12 may include any generator capable of converting the mechanical energy to electrical energy, such as an alternator.

Generator 12 may be electrically coupled to an electrical distribution system (not shown in FIGS. 1A and 1B) and configured to supply electrical power to the electrical distribution system. In some examples, the electrical distribution system may include one or more connections to an electrical grid, such that generator 12 may provide an alternative electrical power supply. In other examples, the electrical distribution system may be an islanded distribution system that may be isolated from any other electrical grid, such that generator 12 may be an on-demand power supply. In examples where system 10A or 10B is a standby or backup system, generator 12 may be coupled to the electrical distribution system through a transfer switch. When generator 12 is not supplying electrical power above a threshold, the transfer switch may be configured to be in an open position. During startup of engine 14, the transfer switch may be configured to shut in response to generator 12 supplying electrical power above the threshold.

Systems 10A and 10B include engine 14. Engine 14 may be configured generate mechanical energy from a fuel source and transfer the mechanical energy to generator 12 for conversion into electrical power. Engine 14 may include any engine capable of generating mechanical energy from a fuel source, such as a diesel engine. Engine 14 may be fluidically coupled to the fuel source (not shown). For example, engine 14 may be fluidically coupled to a diesel fuel source, a gasoline fuel source, a biofuel fuel source, or any other fuel source that may provide fuel to engine 14.

In some examples, engine 14 may include a starter system 16 electrically coupled to starter battery system 20 and configured to provide electrical power to starter system 16. Starter system 16 may be configured to receive the electrical power from starter battery system 16 and provide torque to achieve a starting cranking speed of engine 14. Starter battery system 20 may include one or more batteries that discharge stored electrical power to starter system 16 in response to an indication of startup of engine 14.

Engine 14 includes a heat exchange system 18 fluidically coupled to engine 14 and an engine heating source, such as engine heating source 22A or 22B. Heat exchange system 18 may be configured to circulate a heat exchange fluid through engine 14 and engine heating source 22A or 22B. For example, heat exchange system 18 may include an open or closed circuit heat exchange system that includes a pump configured to circulate heat exchange fluid through heat exchange system 18 and one or more heaters or heat exchangers configured to add or remove heat from the heat exchange fluid. During operation of engine 14, heat exchange system 18 may maintain the heat exchange fluid below a maximum heat exchange fluid temperature by circulating heat exchange fluid through an engine 14 that is hot and removing heat from the heat exchange fluid using a heat exchanger. Heat exchange system 18 may include any fluidic heat exchange system associated with engine 14. Heat exchange system 18 may include any of a variety of systems including, but not limited to, a coolant system, an engine lubrication system, an engine aftertreatment system, an engine fuel supply system, an external heating system, and the like.

Prior to startup of engine 14, heat exchange system 18 may maintain heat exchange fluid temperature above a minimum heat exchange fluid temperature by circulating heat exchange fluid through an engine 14 that is cold and adding heat to the heat exchange fluid using engine heating source 22A or 22B. In some examples, heat exchange system 18 may include control instrumentation, such as a controller, a control valve, and a thermocouple, to control a temperature of heat exchange fluid in heat exchange system 18, such as by controlling heat exchange fluid flow of heat exchange system 18.

In some examples, generator 12 and engine 14 may be configured to startup from a standby or off condition. For example, generator 12 and engine 14 may be used as a backup power source for the electrical distribution system, such that if the electrical distribution system loses a main power supply, generator 12 and engine 14 may be brought up to operating conditions to supply the electrical distribution system with electrical power. To bring generator 12 and engine 14 to operating conditions, certain startup conditions may be maintained when generator 12 and engine 14 are at a standby or off condition. Startup conditions that may be maintained may include a temperature of engine 14 above a minimum engine temperature threshold, a temperature of a lubricant above a minimum operating threshold, a temperature of an engine after-treatment system above a minimum operating threshold, a temperature of heat exchange fluid above a minimum heat exchange fluid temperature threshold, a temperature of the environment within enclosure 26 above a minimum enclosure temperature threshold, a charge of starter battery system 20 above a minimum charge threshold, a temperature of starter battery system 20 above a minimum starter battery temperature threshold, and any other condition of a component of generator 12, engine 14, and/or enclosure 26 that affects startup of generator 12 and/or engine 14 and may utilize power.

In some examples, conditions or systems of generator 12, engine 14, and/or enclosure 26 may be maintained at startup conditions using a renewable energy-powered energy source, such as electrical renewable energy-powered energy source 30A or thermal renewable energy-powered energy source 30B. In a conventional generator set system, an electrical distribution system, such as an electrical mains system, may provide electrical power to maintain generator 12, engine 14, and/or enclosure 26 at startup conditions. Although accessory systems used to maintain generator 12, engine 14, and/or enclosure 26 at startup conditions may not utilize the large amounts of electrical power, over time these small amounts of electrical power may result in high energy costs.

A renewable energy-powered energy source may provide a source of energy other than that supplied by electrical power from an electrical distribution system. A renewable energy-powered energy source may provide relatively low levels of energy continuously or semi-continuously over a long period of time to supplement or replace electrical power from an electrical distribution system in powering accessory systems used to maintain generator 12, engine 14, and/or enclosure 26 at startup conditions. These lower levels of energy may be adequate for low loads of accessory systems of engine 14, generator 12, and/or enclosure 26 that may be maintained over long periods of time. In the aggregate, such renewable energy-powered energy sources may reduce or eliminate an electrical power supply from the electrical distribution system and reduce more expensive power usage.

Renewable energy-powered energy sources may include any sources or systems that harvest renewable energy resources such as wind, sunlight, geothermal heat, or the like. Renewable energy-powered energy sources that may be used include, but are not limited to: thermal renewable energy-powered energy sources, solar renewable energy-powered energy sources, wind power renewable energy-powered energy sources, geothermal renewable energy-powered energy sources, biofuel renewable energy-powered energy sources, hydroelectric renewable energy-powered energy sources, and the like.

In some examples, a system 10A may use electricity generated from renewable energy sources to maintain engine 14 at startup conditions. For example, wind, solar, or thermal energy may be converted to electrical energy that may be used to power components associated with startup of engine 14. FIG. 1A is a conceptual and schematic block diagram illustrating an example system 10A for maintaining an engine at startup conditions using electrical renewable energy from electrical renewable energy-powered energy source 30A.

Electrical renewable energy-powered energy source 30A may include any renewable energy system configured to convert renewable energy resources to electrical energy. For example, wind, solar, or thermal energy may be converted to electrical energy that may be used to power components associated with startup of an engine. Electrical renewable energy-powered energy sources that may be used include, but are not limited to: solar sources, such as photovoltaic energy systems; wind sources, such as wind turbines; thermal sources, such as thermoelectric generators; hydroelectric sources, such as hydroelectric turbines; and the like.

Electrical renewable energy-powered energy source 30A may include equipment for converting renewable energy sources to electrical power. For example, a wind or hydroelectric turbine may include a generator configured to convert mechanical energy to electrical energy; a photovoltaic system may include photovoltaic cells configured to convert solar energy to electrical power; a thermoelectric system may include a thermoelectric module configured to convert thermal energy to electrical power; and the like.

Electrical renewable energy-powered energy source 30A may include equipment for distributing electrical power to various components of system 10A. For example, electrical renewable energy-powered energy source 30A may include current and voltage regulation devices to condition electrical current for components of system 10A.

In some examples, starter battery system 20 may be electrically coupled to electrical renewable energy-powered energy source 30A. As explained above, batteries of starter battery system 20 may discharge due to charge cycling, temperature cycling, extended periods of time, or the like. Starter battery system 20 may be configured to receive electrical power from electrical renewable energy-powered energy source 30A, store the electrical power in batteries, and discharge the stored electrical power to starter system 16 above a minimum discharge voltage.

In some examples, engine heating source 22A may be electrically coupled to electrical renewable energy-powered energy source 30A. In some examples, engine heating source 22A may be configured to receive electrical power from electrical renewable energy-powered energy source 30A, convert the electrical power to thermal energy, and transfer the thermal energy to heat exchange fluid of heat exchange system 18. Engine heating source 22A may be fluidically coupled to heat exchange system 18, such that heat exchange fluid from heat exchange system 18 may be in thermal contact with engine heating source 22A. In some examples, engine heating source 22A includes a heater that is in thermal contact with heat exchange fluid of heat exchange system 18.

In some examples, engine heating source 22A may include a resistive heater, which may convert electrical power form electrical renewable energy-powered energy source 30A to heat using electrical resistance. The resistive heaters may be used to heat the heat exchange fluid of heat exchange system 18, or may be positioned near or within engine 14 to directly heat engine 14.

In some examples, enclosure heating system 24A may be electrically coupled to electrical renewable energy-powered energy source 30A. Enclosure heating system 24A may be configured to receive electrical power from electrical renewable energy-powered energy source 30A, convert the electrical power to thermal energy, and output the thermal energy to a volume of enclosure 26. For example, enclosure heating system 24A may be a resistive heater configured to heat ambient air of enclosure 26.

Controller 32 may be communicatively coupled to and configured to control components of system 10A. For example, controller 32 may be configured to manage operation of components of system 10A based on operational inputs for system 10A. Operational inputs of system 10A may include, but are not limited to: temperature setpoints, such as for heat exchange fluid of heat exchange system 18 or ambient air of enclosure 26; charge setpoints of starter battery system 20; startup sequence and timing of engine 14 and generator 12; and the like.

In some examples, controller 32 may be configured to cause electrical renewable energy-powered energy source 30A to maintain a charge of starter battery system 20 with electrical renewable energy. For example, controller 32 may be configured to monitor a battery charge of starter battery system 20. Controller 32 may be configured to cause, in response to the battery charge of starter battery system 20 falling below a threshold, electrical renewable energy-powered energy source 30 to discharge electrical power to starter battery system 20 and starter battery system 20 to store the electrical power until the battery charge is above a threshold.

In some examples, controller 32 may be configured to cause electrical renewable energy-powered energy source 30A to supply heat to engine heating source 22A using renewable energy-derived electrical power. For example, controller 32 may be configured to be monitor a temperature of engine 14. Controller 32 may be configured to cause, in response to the temperature of engine 14 or heat exchange fluid in heat exchange system 18 falling below a threshold, electrical renewable energy-powered energy source 30A to discharge electrical power to engine heating source 22A. Engine heating source 22A may use the discharged electrical power to heat the heat exchange fluid of heat exchange system 18 and circulate heat exchange fluid through heat exchange system 18 to maintain the temperature of engine 14 and/or heat exchange fluid above a threshold temperature.

In some examples, controller 32 may be configured to cause enclosure heating system 24A to supply heat to enclosure 26 using electrical renewable energy. For example, controller 32 may be configured to monitor a temperature of ambient air in enclosure 26. Controller 32 may be configured to cause, in response to the temperature of ambient air in enclosure 26 falling below a threshold temperature, electrical renewable energy-powered energy source 30A to discharge electrical power to enclosure heating system 24A. Enclosure heating system 24A may use the discharged electrical power to heat the ambient air of enclosure 26.

By using electrical power derived from renewable energy sources to maintain engine 14 at startup conditions, a generator set may use less electrical power from an electrical grid than generator sets that do not use renewable energy sources. For example, electrical power from renewable energy-powered energy sources may supplement electrical power to one or more components of the system. As another example, electrical power from renewable energy-powered energy sources may be configured to supply levels of power that may more closely match the power usage of components of the generator set for power maintenance than the electrical power supply of an electrical grid. Additionally or alternatively, using electrical power from renewable energy-powered energy sources may allow the generator set to operate in an islanded configuration independent of an electrical grid.

In some examples, a system 10B may use thermal renewable energy-powered energy sources to maintain an engine 14 at startup conditions. For example, geothermal, solar, and biomass heat energy may be used to produce thermal energy for components associated with startup of an engine. FIG. 1B is a conceptual and schematic block diagram illustrating an example system 10B for maintaining an engine 14 at startup conditions using electrical renewable energy from thermal renewable energy-powered energy source 30B.

Thermal renewable energy-powered energy source 30B may include any renewable energy system configured to transfer thermal renewable energy resources. For example, geothermal, solar, or biomass energy may be used to power components associated with startup of an engine 14. Thermal renewable energy-powered energy sources that may be used include, but are not limited to: solar sources, such as solar heating systems; geothermal sources, such as geothermal pumps and heat exchangers; biomass sources, such as biomass burners; and the like.

Thermal renewable energy-powered energy source 30B may include equipment for converting renewable energy sources to thermal energy that may be used by system 10B. For example, a geothermal system may include piping, pumps, and heat exchangers configured to transfer thermal energy from the ground to a liquid; a biomass burner system may include furnaces configured to convert potential energy to thermal energy; a solar heating system may include a bath configured to convert solar energy to thermal energy; or the like.

Thermal renewable energy-powered energy source 30B may include equipment for distributing thermal energy to various components of system 10B. For example, thermal renewable energy-powered energy source 30B may include piping, pumps, heat exchangers, flow meters, valves, and other fluid transfer, heat transfer, and process control equipment to distribute thermal energy streams, such as fluid streams of a heating medium, from thermal sources of thermal renewable energy-powered energy source 30B to components of system 10B.

Engine heating source 22B may be fluidically coupled to thermal renewable energy-powered energy source 30B. Engine heating source 22B may be configured to receive a fluid stream that includes thermal energy from thermal renewable energy-powered energy source 30B and transfer the thermal energy from the fluid stream to heat exchange fluid of heat exchange system 18. Engine heating source 22B may be fluidically coupled to heat exchange system 18, such that heat exchange fluid from heat exchange system 18 may be in thermal contact with engine heating source 22B. In some examples, engine heating source 22B is a heat exchanger. For example, engine heating source 22B may include heat exchangers that are coupled to thermal renewable energy-powered energy source 30B on a hot side and heat exchange system 18 on a cold side. In some examples, engine heating source 22B may be part of thermal energy source 30B or heat exchange system 18.

Enclosure heating system 24B may be fluidically coupled to thermal renewable energy-powered energy source 30A. Enclosure heating system 24B may be configured to receive thermal energy from thermal renewable energy-powered energy source 30B and output the thermal energy to a volume of enclosure 26. For example, enclosure heating system 24B may be a heat exchanger that is coupled to thermal renewable energy-powered energy source 30B on a hot side and exposed to ambient air within enclosure 26 on a cold side.

In some examples, starter battery system 20 may be fluidically coupled to thermal renewable energy-powered energy source 30B. As discussed above, batteries of starter battery system 20 may lose their charge over time and may retain a smaller amount of energy when cold. Starter battery system 20 may be configured to receive thermal power from thermal renewable energy-powered energy source 30B. For example, starter battery system 20 may include a heater or heat jacket fluidically coupled to thermal renewable energy-powered energy source 30B. By providing thermal energy to starter battery system 20, starter battery system 20 may lose less charge than if thermal energy was not provided.

Controller 32 may be communicatively coupled to and configured to control components of system 10B. For example, controller 32 may be configured to manage operation of components of system 10B based on operational inputs for system 10B. Operational inputs of system 10B may include, but are not limited to: temperature setpoints, such as for engine 14 or a heat exchange fluid of heat exchange system 18, ambient air of enclosure 26, and batteries of starter battery system 20; startup sequence and timing of engine 14 and generator 12; and the like.

In some examples, controller 32 may be configured to cause thermal renewable energy-powered energy source 30B to supply heat to engine heating source 22B using thermal renewable energy. For example, controller 32 may be configured to be monitor a temperature of engine 14. Controller 32 may be configured to cause, in response to the temperature of engine 14 falling below a threshold temperature, thermal renewable energy-powered energy source 30B to discharge thermal energy, such as a flow of a heated fluid, to engine heating source 22B. Engine heating source 22 may transfer heat from the discharged thermal energy to heat exchange fluid of heat exchange system 18 to heat the heat exchange fluid of heat exchange system 18, and, ultimately, engine 14.

In some examples, controller 32 may be configured to cause enclosure heating system 24B to supply heat to enclosure 26 using thermal renewable energy. For example, controller 32 may be configured to monitor a temperature of ambient air in enclosure 26. Controller 32 may be configured to cause, in response to the temperature of ambient air in enclosure 26 falling below a threshold, thermal renewable energy-powered energy source 30B to discharge thermal energy, such as a flow of heated fluid, to enclosure heating system 24B. Enclosure heating system 24B may transfer heat from the discharged thermal energy to the ambient air of enclosure 26 to heat the ambient air.

In some examples, controller 32 may be configured to cause thermal renewable energy-powered energy source 30B to supply heat to starter battery system 20 using thermal renewable energy. For example, controller 32 may be configured to monitor a temperature of starter battery system 20. Controller 32 may be configured to cause, in response to the temperature of starter battery system 20 falling below a threshold, thermal renewable energy-powered energy source 30B to discharge thermal energy to starter battery system 20, such as a heating jacket contacting starter battery system 20.

By using thermal energy from renewable energy sources to maintain an engine at startup conditions, a generator set may use less electrical power from an electrical grid than generator sets that do not use renewable energy sources. For example, thermal energy from renewable energy-powered energy sources may supplement thermal energy produced by electrical power to one or more components of the system. As another example, thermal energy supplied to the generator set may be transferred with a higher efficiency than thermal energy produced from electrical power supplied by an electrical grid.

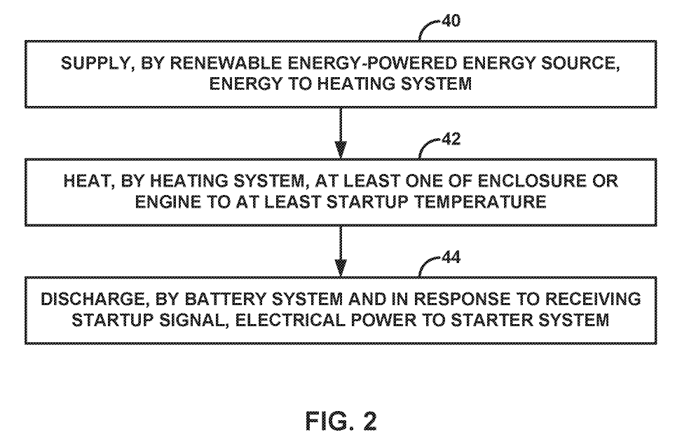

FIG. 2 is a flow diagram illustrating an example technique for maintaining a generator set at startup conditions using renewable energy. The technique of FIG. 2 will be described with concurrent reference to systems 10A and 10B of FIG. 1, although one of ordinary skill will understand that the technique of FIG. 2 may be performed by other systems that include more or fewer components, and that systems 10A and 10B may perform other techniques. For example, one or more control steps performed by a controller may be performed manually or by using another component of system 10.

A controller, such as controller 32, may cause a renewable energy-powered energy source, such as electrical renewable energy-powered energy source 30A or thermal renewable energy-powered energy source 30B, to supply energy, such as electrical power or thermal energy, to a heating system, such as an engine heating source (engine heating source 22A or 22B) or an enclosure heating system (enclosure heating system 24A or 24B) (40). For example, in the example of FIG. 1A, controller 32A may cause electrical renewable energy-powered energy source 30A to supply electrical power to a resistive heater of engine heating source 22A. The resistive heater of engine heating source 22A may heat the heat exchange fluid of heat exchange system 18. As another example, in the example of FIG. 1B, controller 32 may cause a ground heat exchanger of thermal renewable energy-powered energy source 30B to supply thermal energy through a heated medium to a heat exchanger of engine heating source 22B, such as by controlling a pump to circulate a heating medium from the ground heat exchanger of thermal renewable energy-powered energy source 30B to the heat exchanger of engine heating source 22B at a particular flow rate. The heat exchanger of engine heating source 22B may transfer heat to the heat exchange fluid of heat exchange system 18.

Controller 32 may cause the heating system to heat, at least one of engine 14 or enclosure 26 to at least a startup temperature (42). For example, controller 32 may cause a pump of heat exchange system 18 to circulate heat exchange fluid through heat exchange system 18 at a particular flow rate to maintain a temperature of engine 14 above a threshold for startup of engine 14. As another example, controller 32 may cause a resistive heater of enclosure heating system 24A to discharge heated air at a particular rate into a volume of enclosure 26 until a temperature setpoint of ambient air in enclosure 26 has been reached.

During startup, controller 32 may send a startup signal to engine 14 and, in response to receiving the startup signal, engine 14 may startup. For example, in backup power systems connected to an electrical distribution system, the controller may monitor the electrical power supply to the electrical distribution system. In response to detecting a power outage and after a starting time delay, the controller may send the startup signal to starter battery system 20.

Starter battery system 20 may discharge, in response to receiving the startup signal, electrical power to starter system 16 of engine 14 (44). Engine 14 may receive fuel from a fuel supply and begin producing mechanical energy. Due at least in part to renewable energy supplied by a renewable energy-powered energy source, heat exchange fluid of heat exchange system 18 may be above a threshold temperature, such that engine 14 may produce a desired amount of mechanical energy within a period of time. Generator 12 may convert the mechanical energy into electrical power. Once the electrical power supplied by generator 12 is brought above a threshold, the controller may connect generator 12 to the electrical distribution system.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A generator set comprising:
a generator configured to supply power to an electrical system;
an engine mechanically coupled to the generator;
an enclosure housing the engine and the generator;
a heating system configured to heat at least one of the engine or the enclosure to at least a startup temperature; and
a renewable energy-powered energy source configured to supply energy to the heating system to heat the at least one of the engine or the enclosure.

2. The system of claim 1, wherein the heating system comprises at least one of an engine heat exchange system or an enclosure heating system.

3. The system of claim 1, wherein the renewable energy-powered energy source comprises a thermal renewable energy-powered energy source, wherein the heating system comprises a heat exchanger, and wherein the thermal renewable energy-powered energy source is fluidically coupled to the heat exchanger.

4. The system of claim 3, wherein the thermal renewable energy-powered energy source comprises at least one of a geothermal heat exchanger, a solar heater, or a biomass burner.

5. The system of claim 1, wherein the renewable energy-powered energy source comprises an electrical renewable energy-powered energy source, wherein the heating comprises a resistive heater, and wherein the electrical renewable energy-powered energy source is electrically coupled to the resistive heater.

6. The system of claim 5, wherein the electrical renewable energy-powered energy source comprises one of a photovoltaic system or a wind turbine.

7. The system of claim 5, wherein the engine further comprises a starter system, wherein the system further comprises a starter battery system electrically coupled to the electrical renewable energy-powered energy source, and wherein the starter battery is configured to receive electrical energy from the electrical renewable energy-powered energy source and discharge electrical energy to the starter system.

8. The system of claim 1, wherein the heating system is configured to heat a heat exchange fluid above a minimum temperature using the energy supplied by the renewable energy-powered energy source.

9. The system of claim 1, wherein the electrical system is coupled to a telecommunications tower.

10. A method, comprising:
supplying, by a renewable energy-powered energy source, energy to a heating system of a generator set, wherein the generator set comprises the renewable energy-powered energy source, the heating system, a generator configured to supply power to an electrical system, an engine mechanically coupled to the generator, and an enclosure encasing the engine and the generator;
heating, by the heating system, at least one of the engine or the enclosure to at least a startup temperature; and
discharging, by a starter battery system and in response to receiving a startup signal, electrical power to a starter system of the engine.

11. The method of claim 10, wherein the heating system comprises at least one of an engine heat exchange system or an enclosure heating system.

12. The method of claim 10, wherein the renewable energy-powered energy source comprises a thermal renewable energy-powered energy source, wherein the heating system comprises a heat exchanger, and wherein the thermal renewable energy-powered energy source is fluidically coupled to the heat exchanger.

13. The method of claim 12, wherein the thermal renewable energy-powered energy source comprises at least one of a geothermal heat exchanger, a solar heater, or a biomass burner.

14. The method of claim 10, wherein the renewable energy-powered energy source comprises an electrical renewable energy-powered energy source, wherein the heating comprises a resistive heater, and wherein the electrical renewable energy-powered energy source is electrically coupled to the resistive heater.

15. The method of claim 14, wherein the electrical renewable energy-powered energy source comprises one of a photovoltaic system or a wind turbine.

16. The method of claim 10, further comprising receiving, by the starter battery system, electrical energy from the electrical renewable energy-powered energy source.

17. The method of claim 10, wherein the heating system heats a heat exchange fluid above a minimum temperature using the energy supplied by the renewable energy-powered energy source.

18. A controller configured to:
cause a renewable energy-powered energy source to supply energy to a heating system of a generator set, wherein the generator set comprises the renewable energy-powered energy source, the heating system, a generator configured to supply power to an electrical system, an engine mechanically coupled to the generator, and an enclosure encasing the engine and the generator;
cause the heating system to heat at least one of the engine or the enclosure to at least a startup temperature; and
cause a battery system to discharge, in response to receiving a startup signal, electrical power to a starter system of the engine.

19. The controller of claim 18, wherein the heating system comprises at least one of an engine heat exchange system or an enclosure heating system.

20. The controller of claim 18, wherein the heating system heats a heat exchange fluid above a minimum temperature using the energy supplied by the renewable energy-powered energy source.
